(19) United States
(12) Patent Application Publication
(10) Pub. No.: US 2025/0103012 A1
(43) Pub. Date: Mar. 27, 2025

(54) METHOD FOR OPERATING AN ACTUATOR ARRANGEMENT, ACTUATOR ARRANGEMENT, MOTOR VEHICLE

(71) Applicant: Robert Bosch GmbH, Stuttgart (DE)

(72) Inventors: Simon Schrade, Baindt (DE); Volker Mehl, Bruchsal-Untergrombach (DE)

(21) Appl. No.: 18/823,946

(22) Filed: Sep. 4, 2024

(30) Foreign Application Priority Data
Sep. 21, 2023 (DE) 10 2023 209 209.3

(51) Int. Cl. G05B 9/03; B60W 50/02; B60W 50/04

(52) U.S. Cl. CPC G05B 9/03; B60W 50/0205; B60W 50/045; B60W 2050/022

(57) ABSTRACT

A method for operating an actuator arrangement for a motor vehicle. The actuator arrangement includes at least two controllable actuators and a control system with at least two control devices, which are each assigned to one of the actuators and a central control device, in each case connected to the control devices by means of communication technology by communication links. The control devices are controlled in a fault-free normal operating mode of the actuator arrangement by the central control device for controlling the relevant actuators. The control system is monitored for the occurrence of a malfunction in that an operating state of the relevant actuator is monitored. If a malfunction of the control system affecting one of the actuators is recognized, the affected actuator is controlled directly by the control device assigned to it depending on the operating state of the other actuator detected by the monitoring.

### CROSS REFERENCE

The present application claims the benefit under 35 U.S.C. § 119 of German Patent Application No. DE 10 2023 209 209.3 filed on Sep. 21, 2023, which is expressly incorporated herein by reference in its entirety.

### FIELD

The present invention relates to a method for operating an actuator arrangement, in particular for a motor vehicle, wherein the actuator arrangement comprises at least two controllable actuators and a control system with at least two control devices, in each case assigned to one of the actuators, and a central control device, in each case connected to the control devices by means of communication technology by communication links, and wherein the control devices are controlled in a fault-free normal operating mode of the actuator arrangement by the central control device for controlling the relevant actuators.

The present invention also relates to an actuator arrangement and a motor vehicle with such an actuator arrangement.

### BACKGROUND INFORMATION

Methods of the aforementioned type are available in the related art. For example, actuator arrangements for braking systems of motor vehicles are convention, wherein in each case at least one actuator, in particular an electromechanical wheel brake actuator, is assigned in each case to four wheels of the motor vehicle. Each of the actuators is assigned its own control device, which is typically controlled by at least one central control device arranged at a distance from the actuators. In particular, a separate central control device is assigned to two of the wheels of the motor vehicle, for example axle-wise or crosswise, and in this respect is responsible for two-wheel brake actuators. The central control devices typically handle brake force distribution for the entire vehicle by sending appropriate commands to the control devices assigned to the actuators. In order to increase the fail safety of the actuator arrangement, it is conventional to design components redundantly in order to compensate for failures of individual components and/or subsystems.

### SUMMARY

In a method according to the present invention, the control system is monitored for the occurrence of a malfunction, in that an operating state of the relevant actuator is monitored, and if a malfunction of the control system affecting one of the actuators is recognized, the affected actuator is controlled directly by the control device assigned to it depending on the operating state of the other actuator detected by the monitoring. As a result, compared to the aforementioned actuator arrangements, fail safety is advantageously further improved even in the event of malfunctions in the control system without the need for complex redundancies. In this respect, according to an example embodiment of the present invention, in the event of a malfunction, the control device assigned to the affected actuator detects the activity of another actuator, in particular by means of corresponding sensors, and the actuator is automatically switched on without the need for data to be exchanged with the central control device, for example. In particular, the operating state is monitored and/or detected by sensor signals from at least one sensor assigned to the actuator arrangement, in particular a sensor assigned to the affected actuator. Preferably, the central control device and/or communication links between the central control device and the control devices are monitored for the occurrence of a malfunction. Particularly preferably, the central control device is designed to receive signals from at least one further control device, in particular a further central control device, assigned to a vehicle assistance system, in particular for automated and/or autonomous driving, at least one actuating apparatus and/or signals from at least one sensor detecting actuation of the actuating apparatus, and to control at least one of the control devices depending on the signals. Preferably, at least one corresponding communication link between the central control device and the further, in particular the further central, control device, the actuating apparatus and/or the sensor is then monitored for the occurrence of a malfunction. Such malfunctions also affect the corresponding actuator, at least indirectly. For example, the actuating apparatus is designed as a brake pedal, accelerator pedal, and/or steering handle, in particular a steering wheel, wherein a braking request, acceleration request, and/or steering request is specified by its actuation and transmitted to the central control device. In particular, a braking request, acceleration request, and/or steering request can be specified by the central and/or the further, in particular the further central, control device and/or such a request is specified and transmitted to the central control device. Alternatively or additionally, the central control device itself is part of a vehicle assistance system, in particular for automated and/or autonomous driving, wherein signals, in particular in the form of a braking request, acceleration request, and/or steering request, can be specified and/or are specified by the central control device, and at least one of the control devices can be controlled and/or is being controlled depending on the signals.

According to a preferred further development of the present invention, it is provided that the actuators are assigned to one or each of an actuatable apparatus, in particular a wheel braking apparatus, drive apparatus and/or steering apparatus for at least one wheel or one axle of the motor vehicle, and that the relevant apparatus is actuated by the control device upon the control of the actuator. Upon such an assignment of the actuators, the advantages of the method according to the present invention are particularly pronounced. For example, a corresponding actuator with such an apparatus is provided for each of the wheels of the motor vehicle, in particular four wheels. The field of application of the apparatus extends in particular to applications in the automotive sector, in aviation technology, in rail vehicle technology, and/or in medical technology.

According to an example embodiment of the present invention, particularly preferably, it is provided that the actuators are designed as electromechanical actuators and in each case comprise an electric machine, and that the operating state of the actuators is monitored by means of a current sensor and/or rotor position sensor assigned to the relevant machine. Due to the monitoring by means of such sensors, the advantage arises that the operating state is detected particularly easily and reliably. For example, sensors assigned to the affected actuator are used to indirectly monitor the operating state of the other, unaffected actuator. In particular, sensor signals from the sensor(s) are evaluated. For example, sensor signals from such sensors are also evaluated in normal operating mode for correct control of the actuators by the control device assigned to the actuator.

According to a preferred further development of the present invention, it is provided that the operating state of the actuators is monitored by means of an acceleration sensor and/or acoustic sensor assigned to the relevant actuator. Due to the monitoring by means of such sensors, the advantage arises that the operating state is detected particularly easily and reliably. For example, sensors assigned to the affected actuator are used to indirectly monitor the operating state of the other, unaffected actuator. In particular, sensor signals from the sensor(s) are evaluated. Preferably, a combination of different sensors is used, for example, one of the aforementioned current sensors and/or rotor position sensors is also used in order to further increase the accuracy in detecting the operating state.

According to an example embodiment of the present invention, particularly preferably, it is provided that the operating state of the actuators is monitored by means of a wheel speed sensor, steering angle sensor, position sensor of a toothed rack of a steering gear and/or contact force sensor assigned to a wheel of the motor vehicle assigned to the relevant actuator, and/or that the operating state is monitored depending on a driving force, driving torque, braking force and/or braking torque acting on the wheel. Due to the monitoring by means of such sensors, the advantage arises that variables assigned directly to the wheel are detected, which further increases the accuracy of the detection of the operating state for each individual actuator. For example, corresponding sensors of the wheel assigned to the affected actuator are used in order to indirectly monitor the operating state of the other, unaffected actuator. In particular, if the actuators are assigned to one or each wheel braking apparatus or drive apparatus, as described above, a wheel speed is detected at the wheel assigned to the affected actuator, in order to recognize a control of the unaffected actuator. Preferably, a combination of different sensors is used, for example one of the aforementioned current sensors, rotor position sensors, acceleration sensors and/or acoustic sensors is also used in order to further increase the accuracy in detecting the operating state.

According to a preferred further development of the present invention, it is provided that, if a malfunction is recognized, the relevant control device is switched from normal operating mode to a fault operating mode, and that sensor signals from sensors assigned to the actuators are monitored in the fault operating mode, in order to recognize, depending on the sensor signals, whether at least one other of the actuators of the actuator arrangement is being controlled. The fault operating mode is advantageous in ensuring that the monitoring of the sensor signals is only effected as required and therefore in a resource-efficient, in particular energy-efficient manner. Monitoring the sensor signals is a particularly advantageously simple and robust way of indirectly recognizing a corresponding control without the need for a communication link with the corresponding control device of the controlled actuator.

According to an example embodiment of the present invention, particularly preferably, it is provided that, if a control of at least one other actuator is recognized, the actuator affected by the malfunction of the control system is controlled by the control device assigned to it, to support the other actuator. As a result, the advantage arises that the actuator reliably fulfills the task assigned to it, in particular the actuation of a corresponding apparatus, for example jointly with the other actuator, without coordination by means of communication technology of the control devices involved.

According to a preferred further development of the present invention, it is provided that the control of the actuator is interrupted after a specified period of time, and a decision is made depending on sensor signals ascertained after the interruption as to whether and how the control is continued, in particular by comparing sensor signals prior to the start and after the interruption of the control. As a result, it is advantageously ensured that the control of the actuator is effected on a case-by-case basis and, in particular, in an energy-efficient manner, wherein it is recognized in particular whether the previous control of the actuator was sufficient or whether the control strategy needs to be adapted.

According to an example embodiment of the present invention, particularly preferably, it is provided that the control of the actuator is carried out without interruption, and that a decision is made depending on continuously ascertained sensor signals as to whether and how the control is continued, in particular by comparing sensor signals prior to the start of and during the control. As a result, it is advantageously ensured that the control of the actuator is effected continuously, wherein it is recognized in particular whether the previous control of the actuator was sufficient or whether the control strategy needs to be adapted.

According to a preferred further development of the present invention, it is provided that if a malfunction and a control of at least one other actuator are recognized, the other actuator is controlled more strongly, at least for a specified period of time. In this respect, the actuator is excessively actuated, at least for a limited time, for example to temporarily compensate for the malfunction, until the actuator affected by the malfunction is controlled by the increased pulse triggered by the control device assigned to it to support the other actuator, as described above. In particular, the actuator affected by the malfunction is monitored for the corresponding control for supporting the other actuator and, as soon as this is recognized, the stronger control is withdrawn. In this respect, the response time is advantageously shortened, and it is also advantageously ensured that the actuator arrangement continues to operate without loss until the control of the actuator. For example, if the actuators are in each case assigned to wheel braking apparatuses, the other actuator is controlled to generate an increased vehicle deceleration by means of the wheel braking apparatus, until the affected actuator actuates its wheel braking apparatus in support.

According to an example embodiment of the present invention, particularly preferably, it is provided that a fault message is output in the fault operating mode, in particular on a display apparatus. Due to the outputting of the fault message, the advantage arises that the fault operating mode is reliably communicated to the outside, for example in order to be recognized by a user of the actuator arrangement.

An actuator arrangement, in particular for a motor vehicle, according to an example embodiment of the present invention, comprises at least two controllable actuators and a control system with at least two control devices, in each case assigned to one of the actuators, and a central control device, in each case connected to the control devices by means of communication links. It is characterized by the fact that at least one of the control devices is specially designed to carry out the method according to the present invention. This results in the advantages already mentioned.

A motor vehicle according to an example embodiment of the present invention includes the actuator arrangement according to the present invention. This also results in the advantages already mentioned.

Further preferred features and combinations of features result from the disclosure herein. The present invention is explained in more detail below with reference to the figures.

### BRIEF DESCRIPTION OF THE DRAWINGS

FIG. 1 shows an advantageous actuator arrangement according to an example embodiment of the present invention.

FIG. 2 shows a method for operating the actuator arrangement according to an example embodiment of the present invention.

### DETAILED DESCRIPTION OF EXAMPLE EMBODIMENTS

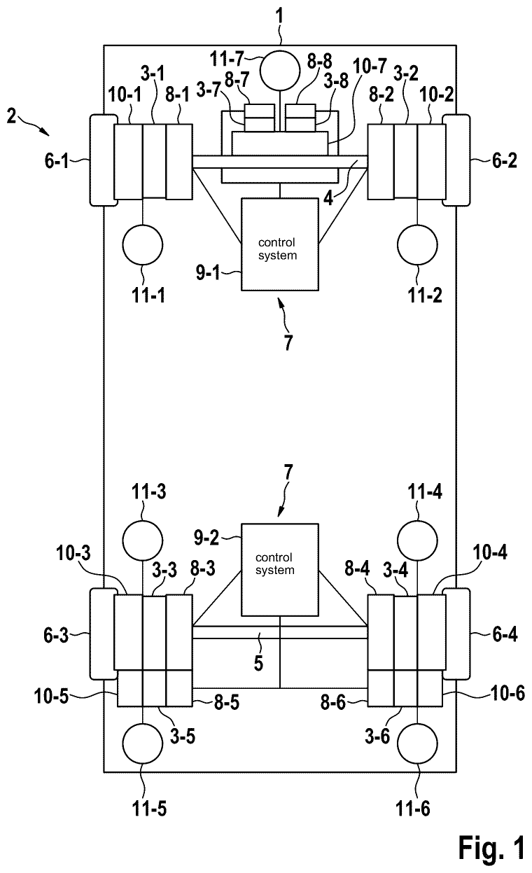

FIG. 1 shows a motor vehicle 1 with an advantageous actuator arrangement 2. In order to demonstrate various possibilities, in the present case the actuator arrangement 2 comprises a large number of components, all of which can be operated using the method to be described below, but are not mandatory in this specific combination.

In the present case, the actuator arrangement 2 comprises a large number of controllable actuators 3-1 to 3-8, which in each case is assigned to a front axle 4 or a rear axle 5 of the motor vehicle and, at least indirectly, to at least one wheel 6-1 to 6-4 of the motor vehicle 1.

Furthermore, the actuator arrangement 2 comprises a control system 7 with a large number of control devices 8-1 to 8-8, in each case assigned to one of the actuators, and two central control devices 9-1 and 9-2, in each case connected to a plurality of the control devices 8-1 to 8-8 by means of communication technology, as indicated by corresponding connecting lines.

As a minimum requirement for the method, the actuator arrangement 2 comprises two of the controllable actuators 3-1 to 3-8 and the control system 7 with two of the control devices 8-1 to 8-8, in each case assigned to a different one of the actuators 3-1 to 3-8, and one of the central control devices 9-1 and 9-2, wherein the present arrangement is also not mandatory in the design for the motor vehicle 1.

Each of the actuators 3-1 to 3-8 is assigned one or in each case one actuatable apparatus 10-1 to 10-7, wherein the apparatuses 10-1 to 10-7 in each case are designed to be controlled by the relevant control device 8-1 to 8-8 upon the control of the relevant actuator 3-1 to 3-8.

Finally, the actuators 3-1 to 3-8, the apparatuses 10-1 to 10-7, and/or the wheels 6-1 to 6-4 are also in each case assigned sensor arrangements 11-1 to 11-7 comprising at least one sensor, which are designed to detect corresponding sensor variables, in particular those representing a relevant operating state of the actuators 3-1 to 3-8.

In the specific exemplary embodiment, the actuators 3-1 to 3-4 are in each case assigned to exactly one of the wheels 6-1 to 6-4 and one of the apparatuses 10-1 to 10-4, wherein the apparatuses 10-1 to 10-4 are in each case designed in particular as a wheel braking apparatus for one of the wheels 6-1 to 6-4. Alternatively or additionally, they are designed as a drive apparatus and/or steering apparatus.

The apparatuses 10-5 and 10-6 are correspondingly assigned to the actuators 3-5 and 3-6, wherein they are designed in particular as wheel braking apparatuses for providing a parking brake function and are in each case arranged on the same wheel 6-3 or 6-4 with in each case one of the apparatuses 10-3 and 10-4, which are also designed as wheel brake apparatuses for providing an operating brake function.

The actuators 3-7 and 3-8 are jointly assigned the apparatus 10-7, which is designed in particular as a steering apparatus for the two wheels 6-1 and 6-2, which are designed as front wheels. In the present case, each of the pairs of actuator 3-1 to 3-8 and apparatus 10-1 to 10-7 formed in this way is assigned exactly one of the sensor arrangements 11-1 to 11-7 and at least, in particular exactly, one of the control devices 8-1 to 8-8.

In the present case, the central control devices 9-1 and 9-2 are distributed evenly over the control devices 8-1 to 8-8, wherein the central control device 9-1 is connected by means of communication technology to at least the control devices 8-1, 8-2, 8-7 and 8-8, and the central control device 9-2 is connected by means of communication technology to at least the control devices 8-3, 8-4, 8-5 and 8-6.

In particular, there are further communication links, not shown for reasons of clarity, between individual control devices 8-1 to 8-8, the sensor arrangements 11-1 to 11-7 and/or the central control devices 9-1 and 9-2.

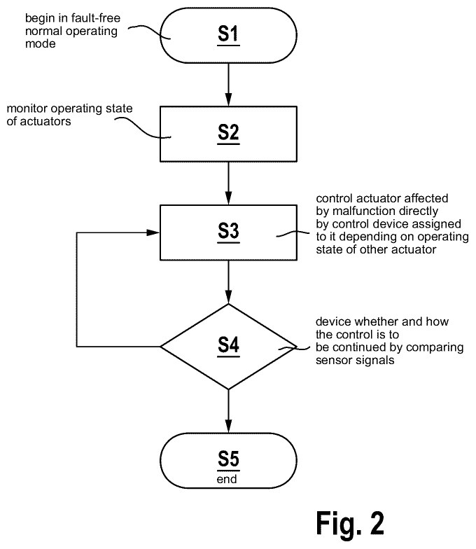

An advantageous method for operating the actuator arrangement 2 is described below with reference to FIG. 2. For this purpose, FIG. 2 shows the method using a flow chart. In particular, the method ensures that the actuator arrangement 2 has a high degree of fail safety.

In a step S1, the method begins in a fault-free normal operating mode of the actuator arrangement 2, in which the control devices 8-1 to 8-8 are controlled in particular depending on braking commands, acceleration commands and/or steering commands for the motor vehicle 1 by the central control device 9-1 or 9-2 assigned to them for controlling their relevant actuators 3-1 to 3-8.

In addition, the control system 7 is monitored for the occurrence of a malfunction, in particular for a failure of one of the central control devices 9-1 and 9-2, for example due to the failure of a corresponding power supply, and/or one of the communication links between one of the central control devices 9-1 and 9-2 and one of the control devices 8-1 to 8-8.

If a malfunction of the control system 2 occurs that affects one of the actuators 3-1 to 3-8, for example if the control device 8-1 to 8-8 assigned to it is no longer receiving or can no longer receive control signals from the corresponding central control device 9-1 or 9-2, the method is continued in a step S2. Preferably, a fault message is now output, in particular on a display apparatus assigned to a driver of the motor vehicle 1.

In step S2, the relevant operating state of the actuators 3-1 to 3-8 is monitored, in the present case with the aid of the corresponding sensor arrangements 11-1 to 11-7, preferably by at least one, in particular all, of the control devices 8-1 to 8-8 assigned to the same type of apparatuses 10-1 to 10-7 and/or actuators 3-1 to 3-8.

Preferably, at least one of the control devices 8-1 to 8-8 is switched from normal operating mode to a fault operating mode, in which sensor signals from sensors of the corresponding sensor arrangements 11-1 to 11-7 are monitored, in order to recognize, depending on the sensor signals, whether at least one other of the actuators 3-1 to 3-8 is being controlled.

Preferably, at least one of the actuators 3-1 to 3-8 is designed as an electromechanical actuator and comprises an electric machine, wherein the operating state and the recognition of the control of the corresponding actuator 3-1 to 3-8 is monitored in particular by means of a current sensor and/or rotor position sensor assigned to the machine as part of the relevant sensor arrangement 11-1 to 11-7.

Alternatively or additionally, the operating state and the recognition of the control are monitored in particular by means of an acceleration sensor and/or acoustic sensor assigned to the relevant actuator 3-1 to 3-8.

In turn, alternatively or additionally, the operating state and the recognition of the control are preferably monitored by means of a wheel speed sensor, steering angle sensor, position sensor of a toothed rack of a steering gear assigned to the wheel 6-1 to 6-4 assigned to the relevant actuator 3-1 to 3-8, and/or contact force sensor, and/or the operating state and the recognition of the control are monitored depending on a drive force, drive torque, braking force and/or braking torque acting on the wheel 6-1 to 6-4.

If a control of at least one other actuator 3-1 to 3-8, which is assigned to the same type of apparatus 10-1 to 10-7, in the present case in particular a wheel braking apparatus, steering apparatus and/or drive apparatus, as the affected actuator 3-1 to 3-8, is recognized in this way, the method is continued with a step S3.

In step S3, the actuator 3-1 to 3-8 affected by the malfunction of the control system 7 is controlled directly by the control device 8-1 to 8-8 assigned to it depending on the operating state of the other actuator 3-1 to 3-8 detected by the monitoring to support the other actuator 3-1 to 3-8.

With reference to the exemplary embodiment shown in FIG. 1, for example, if the actuators 3-1 to 3-4 are in each case assigned to apparatuses 10-1 to 10-4 designed as wheel braking apparatuses, upon the failure of the communication link between the control device 8-1 and the central control device 9-1, the sensor arrangement 11-2 assigned to the actuator 3-2 or the apparatus 10-2 could be monitored accordingly by the control device 8-1, in order to directly recognize the operating state of the actuator 3-2 and thus a braking command, for example a sudden drop in wheel speed, and/or a pitching movement or deceleration of the motor vehicle 1 by means of sensor signals from an acceleration sensor. Alternatively or additionally, the sensor arrangement 11-1 assigned to the actuator 3-1 or the apparatus 10-1 in particular is monitored accordingly by the control device 8-1, in order to indirectly recognize the operating state of the actuator 3-2 and thus a braking command, because, for example, a sudden drop in a wheel speed via the wheels 6-1 to 6-4 would be noticeable at all actuators 3-1 to 3-4.

This would also work in the same way if the apparatuses 10-1 and 10-2 were designed as steering apparatuses (individual wheel actuators, recognition of the operating state, for example by transverse acceleration values or steering angle) or drive apparatuses (recognition, for example by sensor signals from an acceleration sensor).

A further application arises for the actuators 3-7 and 3-8, which are assigned to the apparatus 10-7, which is designed as a steering apparatus, in order to actuate it jointly. If, for example, the communication link between the control device 8-7 of the actuator 3-7 and the central control device 9-1 fails, the control device 8-7 could alternatively monitor the operating state of the actuator 3-8 by evaluating sensor signals from the sensor arrangement 11-7, for example by transverse acceleration values, steering angle, displacement path of a toothed rack/steering rod of the steering apparatus, and/or rotation angle of a shaft of the actuator, and the actuator 3-7, if a corresponding steering command is recognized by the operating state, could be controlled accordingly in order to support the actuator 3-8.

A complete failure of one of the central control devices 9-1 or 9-2 can also be intercepted, for example if the actuators 3-1 to 3-4 are in each case assigned to apparatuses 10-1 to 10-4 designed as wheel braking apparatuses. If, for example, the central control device 9-1 fails completely, the central control device 9-1 can no longer transmit a braking command to the control devices 8-1 and 8-2 and thus to the actuators 3-1 and 3-2 of the front axle 4.

Due to the method according to the present invention, the control devices 8-1 and 8-2 then alternatively evaluate sensor signals from the sensor arrangements 11-3 and/or 11-4 assigned to the rear axle 5 and/or the sensor arrangements 11-1 and/or 11-2 assigned to the front axle 4, in order to directly and/or indirectly detect an operating state of the actuators 3-3 and 3-4 arranged on the rear axle 5, and then support them to fulfill a braking command, for example with a constant or deceleration-dependent braking force. A degradation of the braking system (in particular reduced braking effect) would then be completely prevented. For example, as described above, a wheel speed is detected on at least one of the wheels 6-1 to 6-4 by means of the corresponding sensor arrangement 11-1 to 11-4. An actuation of at least one of the actuators 3-3 and 3-4 is then recognized in particular if the wheel speed drops at any of the wheels 6-1 to 6-4.

Alternatively, the braking force is reduced to a specified value, although the overall possible braking effect is still greater than if the corresponding actuators were to fail completely. The same procedure would be possible if the motor vehicle 1 comprises an all-wheel drive and the corresponding actuators 3-1 to 3-4 are in each case assigned to drive apparatuses, so that acceleration commands could still be reliably met here as well.

These applications are merely intended to serve as examples to demonstrate the advantages of the method according to the present invention. In view of the complexity of the exemplary embodiment shown in FIG. 1, it goes without saying that any other control and monitoring systems can be realized or are realized.

After a specified period of time, the control of the corresponding actuator 3-1 to 3-8 is at least partially withdrawn, in particular interrupted, and the method is continued with a step S4. In step S4, depending on the sensor signals ascertained after the reset or interruption, a decision is made as to whether and how the control is to be continued, in particular by comparing sensor signals prior to the start and after the reset or interruption of the control.

As an alternative to resetting or interrupting the control, the sensor signals are continuously detected and, in step S4, initially compared with sensor signals present prior to the start of the control, without changing the control.

If it is decided to maintain or continue the control, the method jumps back to step S3, wherein the control strategy is adapted in particular depending on the sensor signals, for example to actuate the corresponding apparatus more or less strongly in order to fulfill an aforementioned command with regard to braking, propulsion and/or steering.

If it is decided to terminate or not resume the control because, for example, it is recognized depending on the sensor signals that the aforementioned command with regard to braking, propulsion and/or steering has been reached, the method is terminated with a step S5.

What is claimed is:

1. A method for operating an actuator arrangement for a motor vehicle, wherein the actuator arrangement includes at least two controllable actuators and a control system with at least two control devices each assigned to one of the actuators, and a central control device connected to the control devices using communication technology by communication links, and wherein the control devices are controlled in a fault-free normal operating mode of the actuator arrangement by the central control device for controlling the actuators, the method comprising:
monitoring the control system for an occurrence of a malfunction;
monitoring an operating state of the actuators; and
based on recognizing a malfunction of the control system affecting one of the actuators, controlling the affected actuator directly by the control device assigned to the affected actuator depending on an operating state of another actuator detected by the monitoring.

2. The method according to claim 1, wherein each respective actuator of the actuators is assigned to an actuatable apparatus for at least one wheel or one axle of the motor vehicle, the actuatable apparatus including wheel braking apparatus and/or drive apparatus and/or steering apparatus, the actuatable apparatus being is actuated by the control device upon control of the respective actuator.

3. The method according to claim 1, wherein the actuators are electromechanical actuators and each includes an electric machine, and the operating state of the each of the actuators is monitored using a current sensor and/or rotor position sensor assigned to the electric machine of the actuator.

4. The method according to claim 1, wherein the operating state of each of the actuators is monitored by using an acceleration sensor and/or acoustic sensor assigned to the actuator.

5. The method according to claim 1, wherein:
the operating state of each of the actuators is monitored using a wheel speed sensor and/or steering angle sensor and/or position sensor of a toothed rack of a steering gear and/or contact force sensor assigned to a wheel of the motor vehicle assigned to the actuator, and/or
the operating state of each of the actuators is monitored depending on a driving force and/or driving torque and/or braking force and/or braking torque acting on the wheel assigned to the actuator.

6. The method according to claim 1, wherein based on a malfunction being recognized, the control device assigned to the affected actuator is switched from normal operating mode to a fault operating mode, and sensor signals from sensors assigned to the actuators are monitored in the fault operating mode, in order to recognize, depending on the sensor signals, whether at least one other of the actuators of the actuator arrangement is being controlled.

7. The method according to claim 6, wherein based on a control of at least one other actuator being recognized, the affected actuator is controlled by the control device assigned to the affected actuator, to support the other actuator.

8. The method according to claim 7, wherein the control of the affected actuator is interrupted after a specified period of time, and a decision is made depending on sensor signals ascertained after the interruption as to whether and how the control is continued, by comparing sensor signals prior to a start of and after the interruption of the control.

9. The method according to claim 7, wherein the control of the affected actuator is carried out without interruption, and a decision is made depending on continuously sensor signals ascertained as to whether and how the control is continued, by comparing sensor signals prior to a start of and during the control.

10. The method according to claim 6, wherein based on the malfunction being recognized, and based on a control of at least one other actuator being recognized, the other actuator is controlled more strongly, at least for a specified period of time.

11. The method according to claim 6, wherein a fault message is output on a display apparatus in the fault operating mode.

12. An actuator arrangement for a motor vehicle, the actuator arrangement comprising:
at least two controllable actuators;
a control system with at least two control devices each assigned to one of the actuators; and
a central control device connected to the control devices by communication links;
wherein at least one of the control devices is configured to:
monitor the control system for an occurrence of a malfunction,
monitor an operating state of the actuators, and
based on recognizing a malfunction of the control system affecting one of the actuators, controlling the affected actuator directly by the control device assigned to the affected actuator depending on an operating state of another actuator detected by the monitoring.

13. A motor vehicle, comprising:
actuator arrangement for the motor vehicle, the actuator arrangement including:
at least two controllable actuators;
a control system with at least two control devices each assigned to one of the actuators; and
a central control device connected to the control devices by communication links;
wherein at least one of the control devices is configured to:
monitor the control system for an occurrence of a malfunction,
monitor an operating state of the actuators, and
based on recognizing a malfunction of the control system affecting one of the actuators, controlling the affected actuator directly by the control device assigned to the affected actuator depending on an operating state of another actuator detected by the monitoring.
